(19) United States
(12) Patent Application Publication
(10) Pub. No.: US 2015/0324528 A1
(43) Pub. Date: Nov. 12, 2015

(54) SYSTEM AND METHOD FOR TRACKING PATIENT-SERVICE PROVIDER INTERACTIONS

(71) Applicant: Tracy A. Chang, Oak Creek, WI (US)

(72) Inventor: Tracy A. Chang, Oak Creek, WI (US)

(21) Appl. No.: 14/709,273

(22) Filed: May 11, 2015

Related U.S. Application Data
(60) Provisional application No. 61/992,132, filed on May 12, 2014.

(51) Int. Cl. G06F 19/00; H04W 4/00

(52) U.S. Cl. CPC G06F 19/323; H04W 4/008

(57) ABSTRACT

Disclosed is a system and method for tracking patient-service provider interactions. In some implementations, a method includes gathering near real-time information about patient interactions with staff in healthcare facilities such as hospitals, nursing care facilities, retirement communities, home health care environments, assisted living facilities, and senior living facilities. The patient interaction information can be used to help ensure accurate health care information is collected from patient and healthcare provider interactions using a wearable identification transceiver having an embedded microprocessor system as well as an integrated RFID reader and an RFID tag.

### RELATED APPLICATIONS

This application claims the benefit of U.S. Provisional Application No. 61/992,132, entitled “RFID Patient-Service Provider Tracking Method” and filed on May 12, 2014, which is incorporated herein by reference in its entirety.

### FIELD

This application relates generally to healthcare service provider tracking and monitoring and, more particularly, to systems, methods and computer readable media for tracking patient-service provider interactions.

### BACKGROUND

Healthcare providers may benchmark and compare patient satisfaction levels at their own facility with patient satisfaction levels at other organizations based on the quality of care provided to patients by personnel. Medical providers, such as hospitals and the like, may employ hundreds or thousands of personnel such as doctors, healthcare providers, nurses, administrative staff and support staff. Patient-service provider interaction reviews or ratings can provide a measure indicative of patient satisfaction levels and quality of care. The quality of care, in some conventional systems, is gathered from post procedure quality assurance interviews. One problem with this approach may be that the accuracy of the post-procedure benchmarking method and how the information is compiled, relayed back to the health care facility, and shared with the public.

Typically, data may be collected via telephone interview or mailings post release, which may often be weeks after a patient has been discharged. Patients may not have the ability to recall all the necessary, accurate or complete answers for the survey regarding specific to instances that occurred during pre- or post-treatment. Often, a patient may not remember or understand the impact of accurately and precisely answering every question. Also, the skill level of the interviewer and outside influences at the time of the interview, can greatly impact a patient's answers.

At risk for many organizations may be reimbursement funds, public reputation, and future hospital stays. The stakes can be very high for healthcare providers.

Some implementations were conceived in light of the above-mentioned problems and limitations, among other things.

### SUMMARY

Some implementations have been conceived to address concerns of medical providers and patients regarding an accurate representation of the service and interaction with each patient. A measure of patient-service provider interactions can directly relate to the quality of care provided by the healthcare facility and staff. The measure can be useful in attracting new patients to the facility using an advertising campaign based, in part, on an accurate measure of the quality of care provided. Also, better documentation of patient care may result in higher satisfaction and accountability-based on the level of care that is provided to each patient. Patients may be reassured and comforted knowing they have the ability to review all documented interactions with any staff they come into contact with. The patient may be invited, and encouraged to use a software implementation (described below) to provide feedback and record real time interactions with health care service providers and staff.

Some implementations can include a system for tracking patient-service provider interactions. The system can include a wearable patient identification transceiver having an identification transmitter section, an identification receiver section, a processor section and a power supply section, the wearable identification transceiver being configured with a patient identifier and being configured to transmit a query signal in a first protocol to a wearable service provider identification transmitter and receive a response signal from the wearable service provider identification transmitter, the wearable patient identification transceiver being configured to transmit, in a second protocol, information to an external system. The wearable service provider identification transmitter can include a service provider identifier and configured to transmit the response signal in the first protocol, the response signal including the unique identifier and being responsive to the query signal received from the wearable patient identification transceiver.

The system can also include a computer system configured to receive and store patient-service provider interaction information sent from the wearable patient identification transceiver in the second protocol, the interaction information including one or more of the patient identifier and the service provider identifier.

The wearable patient identification transceiver can further include one or more of a visual indicator, an audible indicator and a tactile/haptic indicator. The wearable patient identification transceiver can further include a human readable form of the patient identifier and a machine readable form of the patient identifier disposed on an outside surface of the wearable patient identification transceiver.

The first protocol can be one of radio frequency identification (RFID), Bluetooth Low Energy (LE), near field communications (NFC). The second protocol can be one of Bluetooth or WiFi.

The system can further include an input device disposed on the wearable patient identification transceiver and configured to receive input from a wearer of the wearable patient identification transceiver. The interaction information can include interaction date and time.

The system can further include a mobile device having a mobile application stored thereon that when executed causes the mobile device to connect to the computer system, retrieve patient interaction information, and cause the patient information to be displayed on a display of the mobile device.

Some implementations can include a method of tracking patient-service provider interactions. The method can include associating a patient identifier of a wearable patient identification transceiver with a patient file in a patient-service provider interaction tacking system. The method can also include receiving, at the wearable patient identification transceiver, a service provider identifier transmitted by a wearable service provider identification transmitter, and storing, at the wearable patient identification transceiver, interaction information including the service provider identifier and an interaction date/time.

The method can further include transmitting, from the wearable patient identification transceiver, the interaction information to the patient-service provider interaction tacking system, and storing, at the patient-service provider interaction tacking system, the interaction information in the patient file. The method can also include receiving, at the patient-service provider interaction tacking system, additional interaction information associated with the interaction information, and storing, at the patient-service provider interaction tacking system, the additional interaction information in the patient file.

The method can also include providing an indication that the service provider identifier has been received, wherein the providing includes one or more of providing a visual indication, providing an audible indication and providing a tactile haptic indication. The additional information can include rating information about the associated interaction.

The method can further include providing a report summarizing interactions recorded during duration of treatment of a patient. A form of the report can include one or more of paper, electronic or visually displayed. The method can also include automatically generating a notification and providing the notification to a healthcare service provider, the patient and any authorized parties having access to the patient's account, when a healthcare service provider has not made a tracked interaction with the patient within a given number of hours.

Some implementations can include a nontransitory computer readable medium having stored thereon software instructions that, when executed by a processor, cause the processor to perform operations. The operations can include associating a patient identifier of a wearable patient identification transceiver with a patient file in a patient-service provider interaction tacking system. The operations can also include receiving, at the wearable patient identification transceiver, a service provider identifier transmitted by a wearable service provider identification transmitter, and storing, at the wearable patient identification transceiver, interaction information including the service provider identifier and an interaction date/time.

The operations can further include transmitting, from the wearable patient identification transceiver, the interaction information to the patient-service provider interaction tacking system, and storing, at the patient-service provider interaction tacking system, the interaction information in the patient file. The operations can also include receiving, at the patient-service provider interaction tacking system, additional interaction information associated with the interaction information, and storing, at the patient-service provider interaction tacking system, the additional interaction information in the patient file.

The operations can also include providing an indication that the service provider identifier has been received, wherein the providing includes one or more of providing a visual indication, providing an audible indication and providing a tactile haptic indication. The additional information includes rating information about the associated interaction. The operations can further include providing a report summarizing interactions recorded during duration of treatment of a patient. A form of the report can include one or more of paper, electronic or visually displayed. The operations can also include automatically generating a notification and providing the notification to a healthcare service provider, the patient and any authorized parties having access to the patient's account, when a healthcare service provider has not made a tracked interaction with the patient within a given number of hours.

### BRIEF DESCRIPTION OF THE DRAWINGS

FIG. 1 is a diagram of an example system for tracking patient-healthcare provider interactions in accordance with at least one embodiment.

FIG. 2 is a diagram of an example wearable patient identification transceiver in accordance with at least one embodiment.

FIGS. 3A and 3B show top and side views of an example wearable patient identification transceiver in a wrist band form in accordance with at least one embodiment.

FIG. 4 is a diagram showing example components of a patient-service provider interaction tracking system in accordance with at least one embodiment.

FIG. 5 is a diagram of an example computing device for patient-service provider interaction tracking in accordance with at least one embodiment.

FIG. 6 is a flowchart of an example process for patient-service provider interaction tracking in a home healthcare environment in accordance with at least one embodiment.

FIG. 7 is a flowchart of an example process for patient-service provider interaction tracking in a nursing home/assisted living facility environment in accordance with at least one embodiment.

FIG. 8 is a flowchart of an example process for patient-service provider interaction tracking in a hospital environment in accordance with at least one embodiment.

### DETAILED DESCRIPTION

It will be appreciated that while a patient-healthcare service provider example is described herein for illustration purposes, implementations could be used in any setting in which it may be desirable for a person (e.g., client, customer, student, inmate, etc.) to track interactions with one or more other people (e.g., sales associates, business service providers, teachers, instructors, educators, correctional officers, law enforcement personnel, military personnel, etc.).

In general, some implementations can provide systems, methods and computer readable media for patients under medical care to create a real time (or near real time) recording of interactions with staff of a health care provider or the like. The patient and staff can each have an ability to earmark events that may impact the quality of healthcare service provided. Also, patient-service provider interactions can be electronically documented. Such a system can provide patients of a health care facility with a way to provide comments, using a custom mobile or computer application, and can identify each service interaction. A system can be configured to perform data survey functions, and to gauge, monitor, report and improve a level of service provided by its personnel as it correlates to the quality of care.

Data and reporting methods described herein can be utilized by both the health care facility and patient to review and benchmark the level of care experienced by the patient throughout their stay. Health care organizations (e.g., hospitals, clinics, etc.) can use the patient interaction tracking data to generate metrics and analytics to help the organization manage employees and provide quality care to patients. The patient and the patient's family, friends or loved ones may enjoy being able to review every recorded interaction with organizational staff and take comfort in knowing they have the ability to provide their own input as it relates to their experiences at their own pace and at a time of their choosing.

Some implementations can be configured to capture interactions and types of interactions in any facility that handles patient care. The interaction data can be stored and can include multiple types of interactions for multiple sources. For example, an application for hospital usage can include functions for performing surveys, patient satisfaction, schedule adherence, performance etc. An application for use by patients can be configured to permit a patient to understand the interactions and types of interactions that occurred during his/her stay.

Interaction data can be stored and used for multiple purposes including hospital, patient, authorized family of patient and authorized third party vendors/providers.

Some implementations can include an application (e.g., mobile application, desktop application, web service application, etc.) and a portal. Thus permitting any device to incorporate, process and display additional information to hospitals (e.g., performance, survey interaction, etc.), patients (review and/or entry of additional information such as survey, etc.), patient family/friends/guardians (e.g., to permit remote checking in on patient interactions with patient, etc.), and vendors/third parties (e.g., to interface, partner and or sell data as authorized and appropriate). For example, the system could integrate, sell or interface with third parties that do surveys.

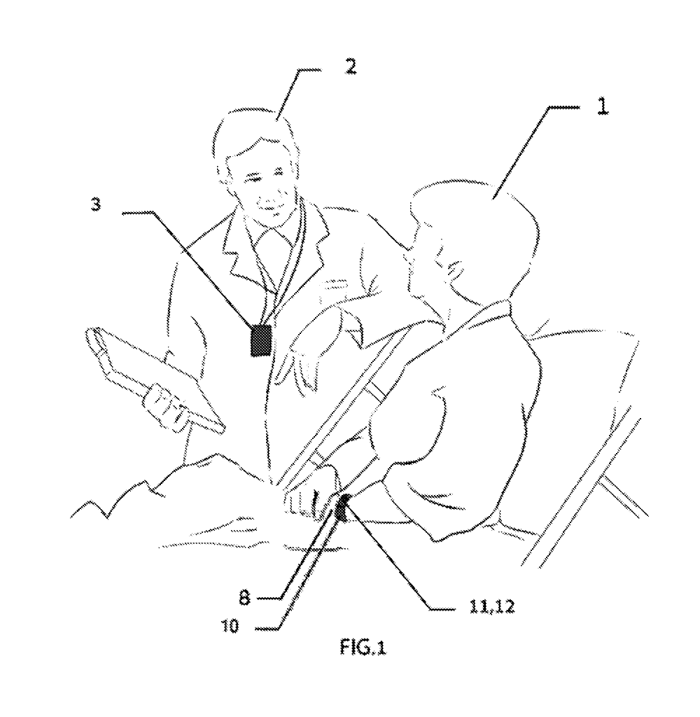

FIG. 1 shows a patient 1 with a wearable patient identification transceiver 10 (e.g., configured as a bracelet or wrist band, a device on a neck lanyard, a device attached to a retractable lanyard or the like) having a proximity sensor (or receiver) 11 (e.g., RFID tag reader or the like) and an identification transmitter 12 (e.g., an RFID tag or the like) on the patient's wrist 8 and a healthcare provider 2 (e.g., physician, nurse, etc.) with his service provider identification transmitter 3 (e.g., RFID tag or the like). The wearable patient identification transceiver 10 can also include a visual indicator (e.g., an LED, a light, a display screen or the like), an audible indicator (e.g., a speaker, buzzer or the like), and/or a tactile/haptic indicator (e.g., a vibration generator or the like). One or more of the visual indicator, audible indicator and tactile/haptic indicator can be used to indicate to the patient when the wearable patient identification transceiver 10 has made a positive read of a service provider identification transmitter 3.

The wearable patient identification transceiver 10 can also include a power supply section including a power source (e.g., battery, rechargeable battery or the like) and circuitry to regulate power and/or charge the battery.

The technology used for proximity detection/identification can include radio frequency identification (RFID), Bluetooth Low Energy (LE), near field communications (NFC), or the like. In general, any proximity detection system capable of communicating identification information and suitable for configuration in a wearable device as described herein could be used.

In operation, a doctor or healthcare provider can bring his/her wearable service provider identification transmitter 3 in close proximity to the patient's wearable transceiver 10. This proximate interaction can cause the receiver 11 to capture the doctor or healthcare provider's 2 information and time stamp the visit. The interaction information can be stored within the wearable transceiver 10 and/or transmitted wirelessly to a server (or other external computer system) to permit the patient, as well as the healthcare provider, to view the event on a computing device (e.g., on desktop computer, a laptop computer, a tablet or other wired or wirelessly connected device).

FIG. 2 shows a patient's wrist 8 with a wearable patient identification transceiver 10 in a wrist band (or bracelet) configuration showing an aluminum crimp mechanism 6 which can permit the bracelet to be adjusted to fit the patient's wrist so as to secure the wearable patient identification transceiver 10 to the patient's wrist 8. Other fasteners can be used such as permanent adhesive, hook and loop, snap, or the like. The receiver 11 is seen as well as where the transmitter 12 is mounted within the bracelet 8 using any suitable method of encapsulating an electronic circuit to keep the patient safe from the circuit and to keep the circuit safe from the environment and patient activities (e.g., baths, showers, and the like). The ID number 16 is shown provided on the band in human readable form as another means of visual identification of the patient.

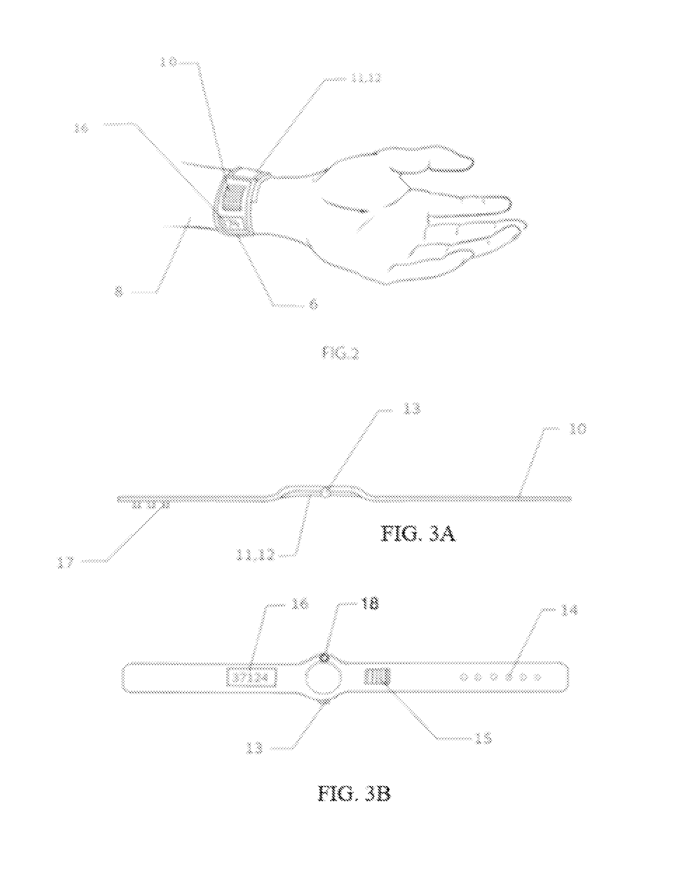

FIGS. 3A and 3B show side and top views of a wearable patient identification transceiver 10. In some implementations, an attachment mechanism for securing the wearable patient identification transceiver to the patient can include sizing holes 14 that are configured to mate with sizing pins 17 to allow the wearable patient identification transceiver 10 to be securely and adjustably mounted to the patient's wrist. An aluminum crimp 6, shown in FIG. 2, may also be utilized. The ID number 16 may be printed on the wearable patient identification transceiver 10 in human readable form to allow visual identification. Also, a machine readable form (e.g., a bar code or the like) of the patient ID number 15 can be provided on the wearable patient identification transceiver 10 to permit a computer to read the machine-readable ID number 15 (e.g., using a bar code reader) and inventory the wearable patient identification transceiver 10. A visual indictor (e.g., LED) 18 can indicate (e.g., blink according to a predefined sequence) when a successful read of a service provider identification transmitter 3 has been performed. The wearable patient identification transceiver 10 can also include an audible indicator and/or a haptic/tactile indicator that can be used in addition to or as an alternative to the visual indicator. The visual indicator can be disposed on a face (e.g., front external surface) of the wearable patient identification transceiver 10 to permit a user to confirm whether a successful read was made of a service provider identification transmitter as well as communicate other modes using various flashing or color sequences (or audible tones/sounds or haptic/tactile feedback).

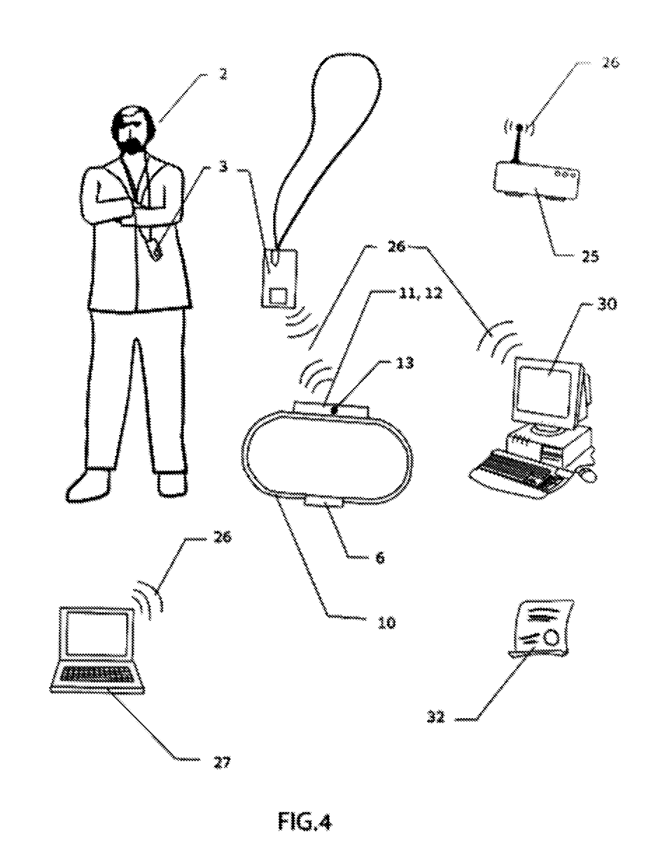

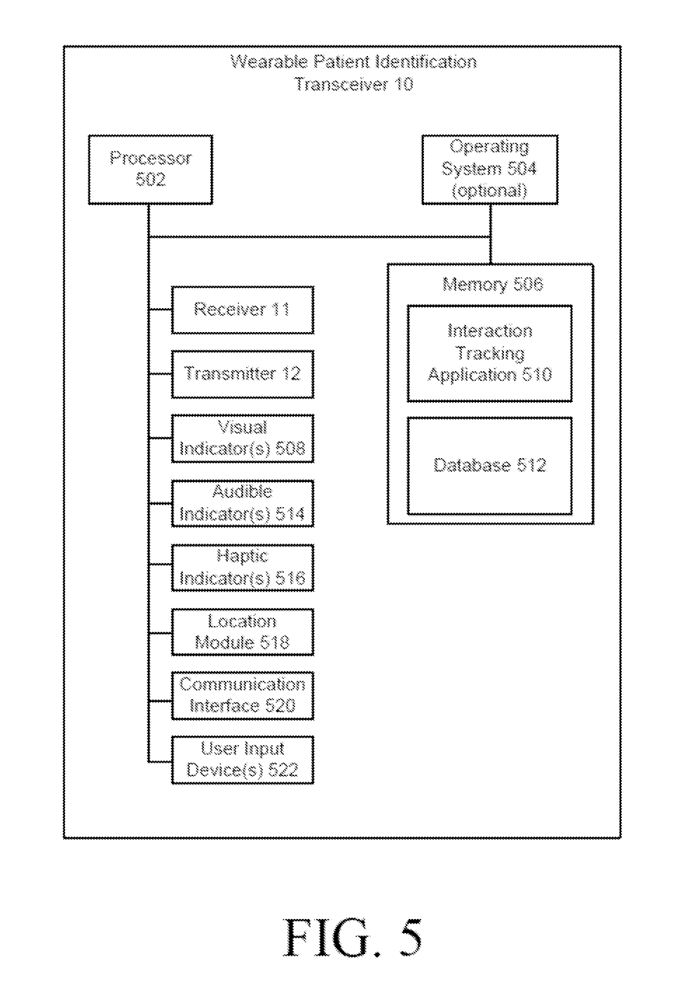

FIG. 4 shows the relationship between a side view of the wearable patient identification transceiver 10 secured with an aluminum crimp mechanism 6 with the receiver 11 and transmitter 12 and a user input device (e.g., button) 13 shown for earmarking instances is shown on the side of the wearable patient identification transceiver 10. An event is shown by any one of the RFID or wireless links 26 between the healthcare provider 2 who wears the service provider identification transmitter 3 and the wearable patient identification transceiver 10. The wearable patient identification transceiver 10 may communicate wirelessly via the wireless link 25 between the wearable patient identification transceiver 10 and an external system (e.g., computer 30 or a laptop 27) via the RFID or wireless links 26. At this point, a database, within computer 30 for example, can provide data from the computer 30, via a wireless link 25, to any wirelessly connected 26 user computer 27 or even wired or wireless computer 30 allowing an authorized patient to enter information regarding the interaction between the healthcare provider 2 and the patient, as tracked by the patient's wearable patient identification transceiver 10.

Additionally, a paper or digital report 32 may be generated that summarizes an entire patient visit (or a portion thereof) from any selected time period as well as summarizes the interactions with one or more selected healthcare service providers.

In some implementations, the system could automatically generate a notification available to healthcare service providers and the patient and the patient's authorized users that a healthcare service provider has not made a tracked interaction or contact with the patient within a given number of hours.

FIG. 5 is a diagram of an example wearable patient identification transceiver 10 in accordance with at least one embodiment. The wearable patient identification transceiver 10 includes a processor 502, an optional operating system 504, a memory 506 having stored therein an interaction tracking application 510 and a database 512, a receiver 11, a transmitter 12, one or more visual indicators 508, one or more audible indicators 514, one or more haptic/tactile indicators 516, an optional location module 518, a communication interface 520 and one or more user input devices 522.

In operation, the processor 502 may execute the interaction tracking application 510 stored in the memory 506. The interaction tracking application 510 can include software instructions that, when executed by the processor, cause the processor to perform operations for interaction tracking in accordance with the present disclosure (e.g., the interaction tracking application 510 can cause the processor to perform one or more of the steps described herein and, in conjunction, can access the database 512). The interaction tracking application 510 can also operate in conjunction with the operating system 504.

The wearable patient identification transceiver 10 can include, but is not limited to, a single processor system, a multi-processor system (co-located or distributed), a cloud computing system, or a combination of the above.

Computers described herein can include, but are not limited to, a desktop computer, a laptop computer, a portable computer, a tablet computing device, a smartphone, a feature phone, a personal digital assistant, a media player, a television, a video display device, an electronic book reader, an entertainment system of a vehicle or the like. Also, devices can include wearable computing devices (e.g., glasses, watches and the like), furniture mounted computing devices and/or building mounted computing devices.

Some devices can be connected to a notification system via a network. The network connecting user devices to the notification system can be a wired or wireless network, and can include, but is not limited to, a WiFi network, a local area network, a wide area network, the Internet, or a combination of the above.

The data storage, memory and/or computer readable medium can be a nontransitory medium such as a magnetic storage device (hard disk drive or the like), optical storage device (CD, DVD or the like), or electronic storage device (RAM, ROM, flash, or the like). The software instructions can also be contained in, and provided as, an electronic signal, for example in the form of software as a service (SaaS) delivered from a server (e.g., a distributed system and/or a cloud computing system).

Moreover, some implementations of the disclosed method, system, and computer readable media can be implemented in software (e.g., as a computer program product and/or nontransitory computer readable media having stored instructions for patient-service provider interaction tracking as described herein). The stored software instructions can be executed on a programmed general purpose computer, a special purpose computer, a microprocessor, or the like.

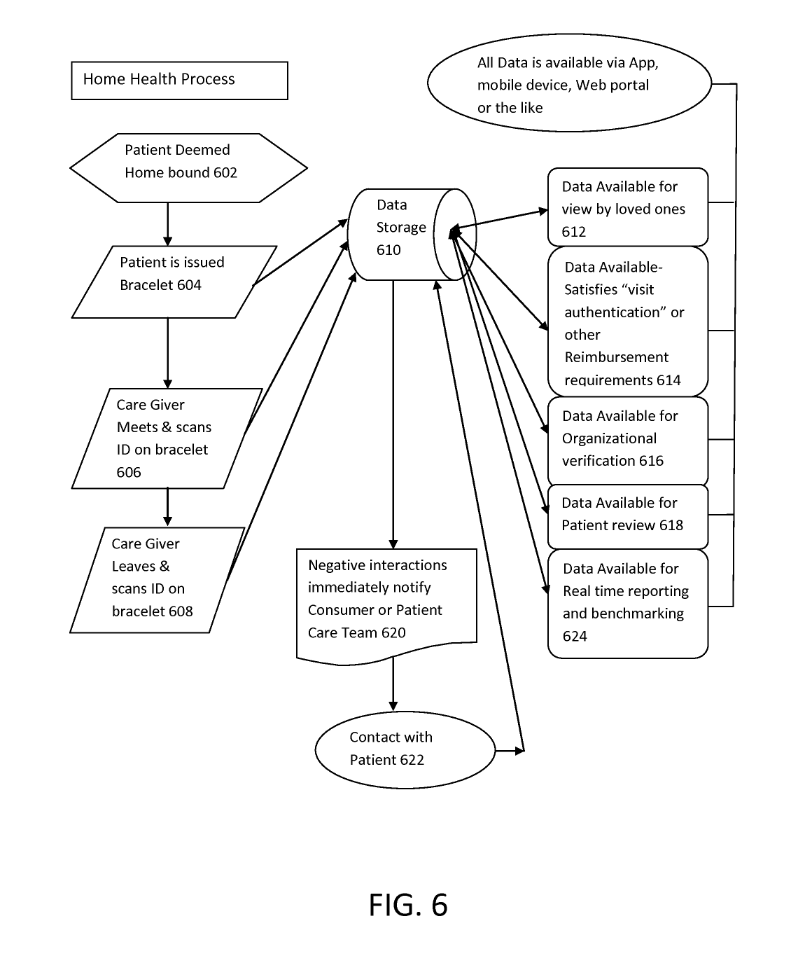

FIG. 6 is a flowchart of an example process for patient-service provider interaction tracking in a home healthcare environment in accordance with at least one embodiment.

Although discharged from health care facility patients may be deemed home bound by an authorized home health professional or physician (602). Care rendered at a patient's residence has historically been difficult to monitor and track. With the issuance of a wearable patient identification transceiver (604), documentation of each visit can be stored in a database (610) can be viewed organizationally (616), by loved ones (612), for reporting and authentication of each visit for Insurance reimbursements (614) and even by the patient (618). Time stamps are initiated and documented each time the badge is in close proximity of the bracelet (606 and 608). The bracelet can include built in buttons which allow the wearer (604) to “rate” an interaction with positive or negative feedback. Negative feedback (620) is immediately flagged and sent to the Consumer or Patient care team who will document in the database (610) receipt and address the situation. Real time reporting (624) will provide the ability to benchmark interactions and provide true transparencies to the Patient, organization and loved ones.

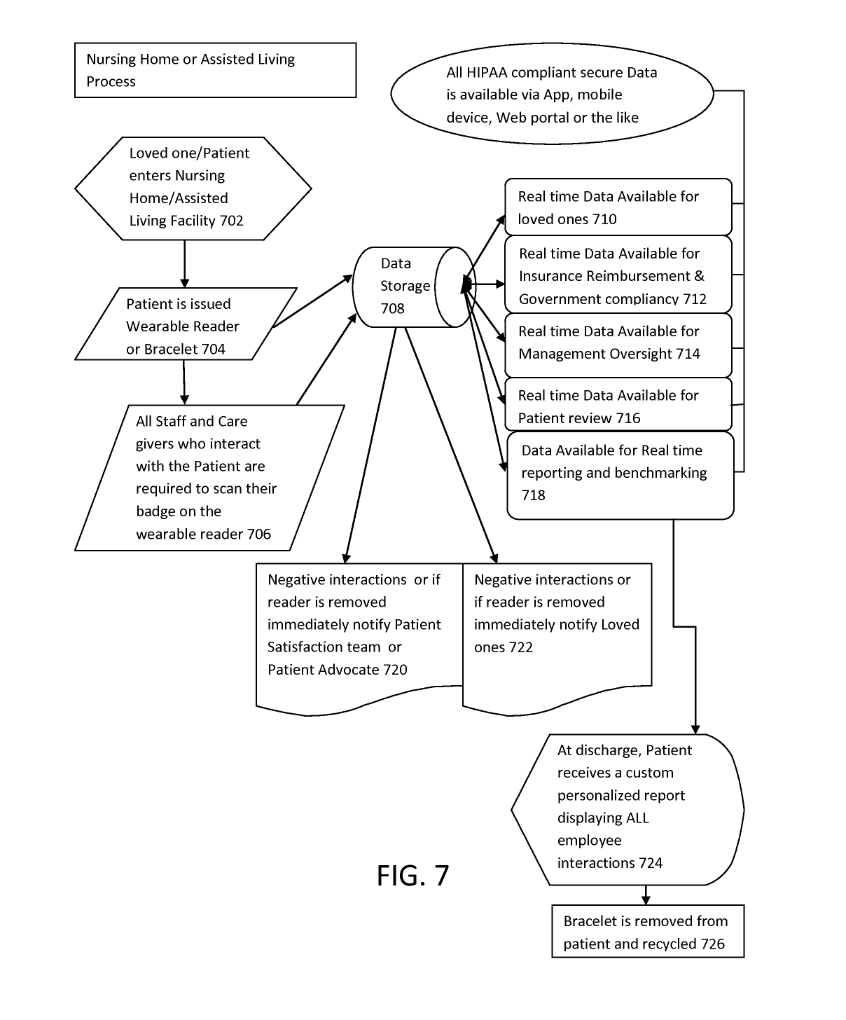

FIG. 7 is a flowchart of an example process for patient-service provider interaction tracking in a nursing home/assisted living facility environment in accordance with at least one embodiment.

To entrust a patient to the care and oversight of a Nursing Home or Assisted living facility can be an extremely difficult decision for both the patient and the loved ones. The level of care and the frequency at which that level of care is provided to the patient are historically two of the main benchmark measures used to form a “reputation” for an organization. Without this unique process, the patient and loved ones do not have the ability to know about all interactions between the patient and staff, without being on site.

At the time of admission (702), a patient can be issued a wearable transceiver (e.g., 10) configured as a bracelet or a lanyard (704). For the duration of the patient's stay, staff may be required to swipe their ID badge (e.g., 3) on the reader during each interaction (706). All interactions can be documented and stored in a database (708). A feature of the reader is that the patient will be able to positively or negatively “rate” each interaction. Although all interactions are recorded in the same data base (708), negative interactions can immediately be sent to loved ones or a patient advocate (720 and 722) for immediate resolution.

Real time interactions are available to the organization (714), the patient (716), and to loved ones (710) who now will have the reassurance that proper care is being administered without the need to be on site. Custom reporting (718) can be generated for insurance and governmental oversight (712). At discharge, all interactions can be compiled into a single report (724) and the bracelet or lanyard can be recycled or discarded (726).

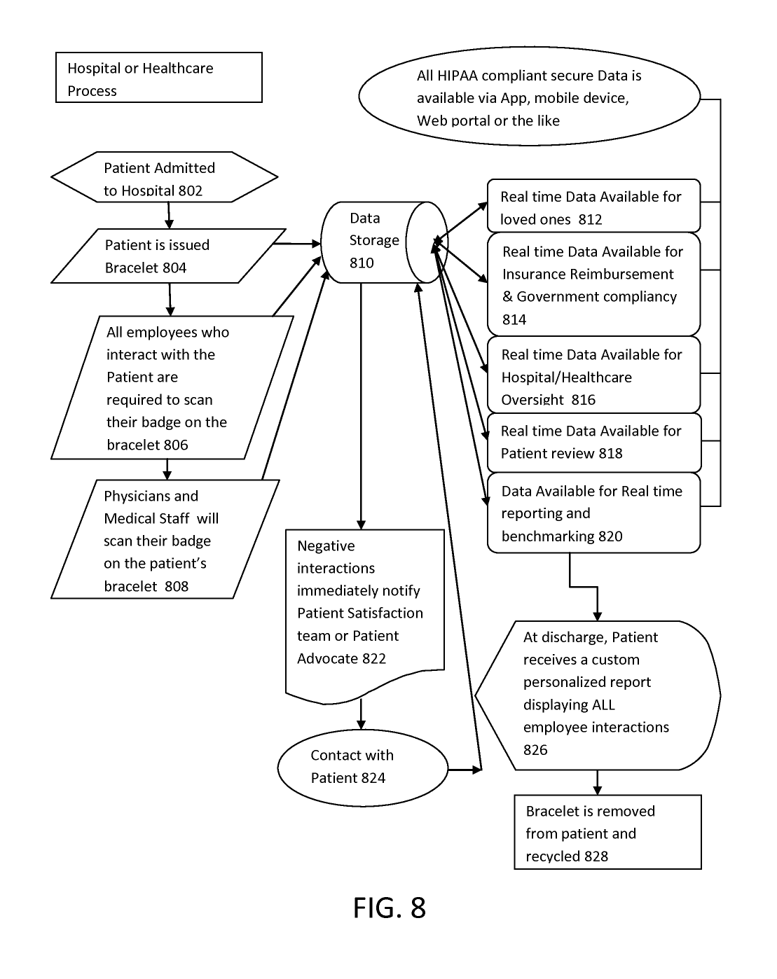

FIG. 8 is a flowchart of an example process for patient-service provider interaction tracking in a hospital environment in accordance with at least one embodiment.

There may be an expectation that superior care, attention to detail, accountability and transparency are afforded to each patient and their loved ones from the moment they enter the facility through the point when they are discharged. When entering the facility and during the admission process (802) a patient is issued a wearable RFID and WiFi enabled Reader bracelet (804) (e.g., 10). Once activated, all employees (806) and physicians/medical staff (808) will be required, upon interaction with the patient, to swipe their ID badges on the patient's bracelet (804). Each ID swipe will generate a real time entry stored in a database (810) which can display the name and picture of the employee along with an optional hyperlink to hierarchical management. An interactive feature on the bracelet is that the patient has the ability to “rate” each employee interaction. “Negative ratings” will immediately notify a Patient Satisfaction team or Patient Advocate (822) who will ensure any issues are properly addressed and resolved in a timely fashion (824). During a patient's stay, the patient (818), loved ones (812), or the organization (816 and 822) can view interactions between the employees and the patient. Patient satisfaction and overall care will improve as a result of the accountability and transparency this process will bring. Customizable Reports (820) will improve organizational efficiencies, staffing and provide needed documentation for reimbursements. At the point of discharge, the patient will be given a full report (826) which will display a complete list of all interactions. The wearable reader is removed from the patient and recycled or discarded (828).

An important aspect of the described matter is that the patient may provide near real time information about the interaction. This will provide a more accurate and reliable recording of each event. As many healthcare providers are rewarded based on the quality of care, this system provides an incentive for the care giver to provide exceptional service during every interaction with every patient wearing these bracelets. A novel feature of the described matter is that the system provides a means to record a caregiver's interactions with the patient and allows both sides the ability to review near real time data. The process will afford limited commentary documentation by either the healthcare provider or patient into the database. This is accomplished through the use of the custom programming which will allow such communication.

To appreciate the advantages of the described subject matter it may be beneficial to understand how conventional service providers interact with their patients and how patients are asked to evaluate the level of service they have received.

In some current processes, a patient may seek care from a health care facility. During the admitting process, a patient may be asked several questions and may be requested to fill out paperwork. The patient may be asked to await the next step in the process, which may include interaction with nursing, medical technicians, or medical staff all possibly requesting further information. Depending on the facility or institution, the process continues with an escort to observation where various other staff will work with the patient. Each encounter requires the medial specialist to input pertinent information into the patient's electronic or paper medical record.

One or more physicians may visit with the patient, assess the situation and determine the next steps in the care giving process. For example, if the patient is to have blood drawn, needs any further testing, is admitted to the hospital, or requires surgery, several interactions with other service provider personnel may follow, such as: central transport, lab, nursing, management, medical assistants, housekeeping, x-ray, etc. All of these personnel may quickly interact with the patient in rapid succession. A patient utilizing the described matter will benefit from the system automatically since all badge swipes will automatically log, date and stamp all staff interactions.

During a standard inpatient admission, it is very common that a patient will come into contact with numerous individuals all working to ensure they are properly cared for. Finally, when the patient arrives in their room, the care continues with multiple visits from the medical staff, nursing, housekeeping, food services, communications, central transportation, social workers, engineering, and other ancillary departments.

At present, physicians and medical staff typically manually document interactions into the patient's medical record. This manual documentation may not always provide detailed service information needed by the organization and the patient. Frequently, a patient's interactions with various, and critically important, staff may not be effectively recorded.

Some systems currently on the market, track an RFID bracelet transmitter, worn by the patient, through a facility. In these instances, RFID readers are strategically placed inside corridors and inside patient doorways. The current process tracks the patient. This disclosed subject matter not only will track the patient, it can track all interactions by hospital employees that come into contact with the patient and provide transparency and accountability by which all parties may benefit.

In some implementations, upon entering a facility, and as part of the admitting process, a patient is issued a disposable RFID wristband with a unique identifier as described herein (e.g., wearable patient identification transceiver 10). In some implementations, the wearable patient identification transceiver 10 includes a wristband that has its own RFID chip as well as an RFID READER, microchip, battery and Wi-Fi, Bluetooth, or any other common communication protocol such as Echelon, BACnet, Modbus or the like capability. It is important to note that conventional systems utilizing RFID tags may only provide the RFID tag/microchip on the patient or “device” to be tracked. A key feature element of the disclosed subject matter is that the patient bracelet includes a proximity reader/receiver (e.g., an RFID reader) to enable the patient to gather the identification information (e.g., RFID ID) of some or all staff interactions. With this, the patient has the ability, with appropriately constructed software and supporting computer and network infrastructure, as disclosed herein, to be able to review any interaction. The patient is provided with a system to earmark specific interactions and can later refer and comment on the specific interaction or employee.

In some implementations, a silicone wristband is utilized that includes a visual indicator, such as a “soft” light LED embedded inside which will illuminate momentarily to confirm the band has read a service providers RFID ID badge and the event has been captured.

Additionally, a button (e.g., disposed on a face or side of the wearable patient identification transceiver 10) can be used by the patient to “earmark” or “tag” a specific interaction. In one example embodiment, the wearable patient identification transceiver 10 includes a silicone wristband approximately ⅛ inch thick and 1 inch wide. In Some implementations, the wearable patient identification transceiver 10 may be imprinted with a unique alpha and numeric identifier.

In some implementations, wearable patient identification transceiver 10 (e.g., RFID wristband) can document details, and transmit those details, in near real time, of some or all interactions between a patient and any staff who brings their ID badge within range of a patient's RFID reader integrated with the wearable patient identification transceiver 10. The interaction information that may be collected and/or stored may be transmitted via WiFi or any common wireless or wired network or communication protocol to a central database.

If the organization does not have a WiFi network, the information may also be retrieved from wearable patient identification transceiver 10 by synchronizing the wearable patient identification transceiver 10 to a communication device (e.g., a centrally located reader) configured to read data from the wearable patient identification transceiver 10 and transmit the data to an external system for storing in a database. The software supporting the collected information on the wristband may be hosted or non-hosted.

At any time, the patient, staff, or even authorized friends, family or loved ones, can log into the software to view a chronological schedule of all interactions between hospital staff and the patient. In one embodiment, no private patient information would display, thus allowing the collected data to be viewed by any source without concerns of PHI or HIPAA violation. The patient, or an authorized representative of the patient, could authorize or approve an access control list of people authorized to access the interaction information concerning the patient.

In the embodiment, upon pressing the small button, or input device, on the side of the wearable patient identification transceiver 10, the patient can revisit any interactions that they had marked at the time of incident.

The software may have the capability to display real time and historical reporting. In one embodiment, staff may be able to add comments into specific areas if needed but not able to modify or remove any chronological badge reads. Badge reads will appear on the report and may display both the picture of the employee accompanied with the employee's first name and last name initial.

In the embodiment of the software a link may be attached to the employee's first name and last initial. The link, if selected, the system may “redirect” to information about the employee's manager or supervisor, including one or more of a prerecorded 10-15 second video clip of the employee's manager, the manager's name, email and/or phone number.

The software may also be available by downloading a specifically designed mobile or desk top application which will be compatible with an iPhone, Android-based or other mobile appliance, standard work station, tablet or laptop. With such software the patient can view their some or all of the patient stay interaction history.

A copy of the patient's “interactional stay” or “interactional report” may be printed at the time of discharge and entered into the patient's discharge paperwork. In one embodiment, access to electronic copies of the patient's interaction report may be accessed by entering the unique identifier code on the wearable patient identification transceiver 10. End users may be asked to enter the code and create a unique User name and password. Such login requirements would serve as the security mechanism specific to the patient's stay. Organizations utilizing the software can run reports gauging patient interactions and frequencies of visit. These reports can be compared to patient satisfaction surveys used to improve satisfaction scores.

The wearable patient identification transceiver 10 may be removed at the time of discharge and discarded, disposed of or recycled.

The patient's profile may be kept on site and available for review via the organization's web site or application for the timeline determined by the organization.

It is contemplated that any optional feature of the inventive variations described may be set forth and claimed independently, or in combination with any one or more of the features described herein. Reference to a singular item, includes the possibility that there is a plurality of the same items present. More specifically, as used herein and in the appended claims, the singular forms “a,” “an,” “said,” and “the” include plural referents unless specifically stated otherwise. In other words, use of the articles allow for “at least one” of the subject item in the description above as well as the appended claims. It is further noted that the appended claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in the to be appended claims shall allow for the inclusion of any additional element irrespective of whether a given number of elements are enumerated in the appended claim, or the addition of a feature could be regarded as transforming the nature of an element set forth in the appended claims. Except as specifically defined herein, all technical and scientific terms used herein are to be given as broad a commonly understood meaning as possible while maintaining to be appended claim validity.

The breadth of the present invention is not to be limited to the examples provided and/or the subject specification.

Further, it is not intended that any section of this specification (e.g., the Summary, Detailed Description, Abstract, Field, etc.) be accorded special significance in describing the invention relative to one another or the appended claims. All references cited are incorporated by reference in their entirety. Although implementations of the disclosed subject matter have been described in detail for purposes of illustration and clarity of understanding, it is contemplated that certain modifications may be practiced within the scope of the disclosed subject matter.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering, proximity detection and computer networking arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various example implementations disclosed herein, systems, methods and computer readable media for tracking patient-service provider interactions.

While the disclosed subject matter has been described in conjunction with a number of implementations, it is evident that many alternatives, modifications and variations would be or are apparent to those of ordinary skill in the applicable arts. Accordingly, Applicant intends to embrace all such alternatives, modifications, equivalents and variations that are within the spirit and scope of the disclosed subject matter.

What is claimed is:

1. A system for tracking patient-service provider interactions, the system comprising:
a wearable patient identification transceiver having an identification transmitter section, an identification receiver section, a processor section and a power supply section, the wearable identification transceiver being configured with a patient identifier and being configured to transmit a query signal in a first protocol to a wearable service provider identification transmitter and receive a response signal from the wearable service provider identification transmitter, the wearable patient identification transceiver being configured to transmit, in a second protocol, information to an external system,
the wearable service provider identification transmitter having a service provider identifier and configured to transmit the response signal in the first protocol, the response signal including the unique identifier and being responsive to the query signal received from the wearable patient identification transceiver; and
a computer system configured to receive and store patient-service provider interaction information sent from the wearable patient identification transceiver in the second protocol, the interaction information including one or more of the patient identifier and the service provider identifier.

2. The system of claim 1, wherein the wearable patient identification transceiver further includes one or more of a visual indicator, an audible indicator and a tactile/haptic indicator.

3. The system of claim 1, wherein the wearable patient identification transceiver further includes a human readable form of the patient identifier and a machine readable form of the patient identifier disposed on an outside surface of the wearable patient identification transceiver.

4. The system of claim 1, wherein the first protocol is one of radio frequency identification (RFID), Bluetooth Low Energy (LE), near field communications (NFC).

5. The system of claim 1, wherein the second protocol is one of Bluetooth or WiFi.

6. The system of claim 1, further comprising an input device disposed on the wearable patient identification transceiver and configured to receive input from a wearer of the wearable patient identification transceiver.

7. The system of claim 1, wherein the interaction information includes interaction date and time.

8. A method of tracking patient-service provider interactions, the method comprising:
associating a patient identifier of a wearable patient identification transceiver with a patient file in a patient-service provider interaction tacking system;
receiving, at the wearable patient identification transceiver, a service provider identifier transmitted by a wearable service provider identification transmitter;
storing, at the wearable patient identification transceiver, interaction information including the service provider identifier and an interaction date/time;
transmitting, from the wearable patient identification transceiver, the interaction information to the patient-service provider interaction tacking system;
storing, at the patient-service provider interaction tacking system, the interaction information in the patient file;
receiving, at the patient-service provider interaction tacking system, additional interaction information associated with the interaction information; and
storing, at the patient-service provider interaction tacking system, the additional interaction information in the patient file.

9. The method of claim 8, further comprising:
providing an indication that the service provider identifier has been received, wherein the providing includes one or more of providing a visual indication, providing an audible indication and providing a tactile haptic indication.

10. The method of claim 8, wherein the additional information includes rating information about the associated interaction.

11. The method of claim 8, further comprising:
providing a report summarizing interactions recorded during duration of treatment of a patient.

12. The method of claim 11, wherein a form of the report can include one or more of paper, electronic or visually displayed.

13. The method of claim 8, further comprising automatically generating a notification and providing the notification to a healthcare service provider, the patient and any authorized parties having access to the patient's account, when a healthcare service provider has not made a tracked interaction with the patient within a given number of hours.

14. A nontransitory computer readable medium having stored thereon software instructions that, when executed by a processor, cause the processor to perform operations including:
associating a patient identifier of a wearable patient identification transceiver with a patient file in a patient-service provider interaction tacking system;
receiving, at the wearable patient identification transceiver, a service provider identifier transmitted by a wearable service provider identification transmitter;
storing, at the wearable patient identification transceiver, interaction information including the service provider identifier and an interaction date/time;
transmitting, from the wearable patient identification transceiver, the interaction information to the patient-service provider interaction tacking system;
storing, at the patient-service provider interaction tacking system, the interaction information in the patient file;
receiving, at the patient-service provider interaction tacking system, additional interaction information associated with the interaction information; and
storing, at the patient-service provider interaction tacking system, the additional interaction information in the patient file.

15. The nontransitory computer readable medium of claim 14, wherein the operations further include:
providing an indication that the service provider identifier has been received, wherein the providing includes one or more of providing a visual indication, providing an audible indication and providing a tactile haptic indication.

16. The nontransitory computer readable medium of claim 14, wherein the additional information includes rating information about the associated interaction.

17. The nontransitory computer readable medium of claim 14, wherein the operations further include:
providing a report summarizing interactions recorded during duration of treatment of a patient.

18. The nontransitory computer readable medium of claim 17, wherein a form of the report can include one or more of paper, electronic or visually displayed.

19. The nontransitory computer readable medium of claim 14, wherein the operations further include automatically generating a notification and providing the notification to a healthcare service provider, the patient and any authorized parties having access to the patient's account, when a healthcare service provider has not made a tracked interaction with the patient within a given number of hours.

20. The system of claim 1, further comprising a mobile device having a mobile application stored thereon that when executed causes the mobile device to:
connect to the computer system;
retrieve patient interaction information; and
cause the patient information to be displayed on a display of the mobile device.
